(19) United States
(12) Patent Application Publication
(10) Pub. No.: US 2013/0079982 A1
(43) Pub. Date: Mar. 28, 2013

(54) CONTROL DEVICE AND METHOD FOR CONTROLLING A HEATING DEVICE FOR A MOTOR VEHICLE

(71) Applicants: Werner Zimmermann, Grobenzell (DE); Matthias Haisch, Landsberg (DE)

(72) Inventors: Werner Zimmermann, Grobenzell (DE); Matthias Haisch, Landsberg (DE)

(21) Appl. No.: 13/381,255

(22) PCT Filed: Apr. 14, 2011
(86) PCT No.: PCT/EP2011/055958

§ 371 Date: Dec. 3, 2012

(30) Foreign Application Priority Data
Apr. 15, 2010 (DE) 10 2010 015 076.2

(51) Int. Cl. B60H 1/00

(52) U.S. Cl. CPC B60H 1/00
USPC 701/36

(57) ABSTRACT

A control device for a motor vehicle heating device is provided, a heating device having the control device, and a motor vehicle having the heating device with the control device and/or the control device. The control device is capable of actuating the heating device on the basis of an ambient temperature of the motor vehicle for operation in a first operating mode or in a second operation mode. A method for controlling a heating device for a motor vehicle includes actuating the heating device for operation in a first operating mode or in a second operating mode on the basis of an ambient temperature of the motor vehicle.

The present invention relates to a control device for a heating device for a motor vehicle, to a heating device for a motor vehicle and also to a motor vehicle having a heating device and/or a control device for a heating device. The invention also relates to a method for controlling a heating device for a motor vehicle.

The engines of modern motor vehicles, in particular diesel engines, are now very efficient and generate less waste heat. Therefore, motor vehicles often have additional heating devices which are used to heat the interior of a motor vehicle when the waste heat from the engine is not sufficient.

Secondly, many modern motor vehicles have heating devices which act as stationary heating systems in order to provide drivers and passengers with a high level of comfort in respect of heating even when the engine is switched off. In this case, the stationary heating system is used to provide heat which in this case is provided, for example, by an air-conditioning system or some other heating system for the interior. To this end, the stationary heating system generally heats up water in a heating circuit which is provided for this purpose and which can be part of the normal heating circuit of the vehicle or can be formed separately. The heated water is then used by a downstream device, such as an air-conditioning system, for heating the passenger compartment as desired. In this case, a stationary heating system of this kind can be switched on or switched off by a user input, for example by means of remote control. However, operation of the stationary heating system or of the heating device after it is switched on is generally based on predefined parameters sets, so-called EOL data (“End-of-Line” data). EOL data of this kind defines control parameters of a heating device, in particular of a stationary heating system, and is generally input into a control device in accordance with the requirements of a motor vehicle manufacturer or a manufacturer of a stationary heating system after production of the stationary heating system. Even in the case of physically identical stationary heating systems, different EOL data sets can produce very different heating behavior and operating states of the stationary heating system or of the heating device and also different heating properties, this relating, in particular, to the heating power used.

A stationary heating system is often also formed in such a way that it can also fulfill an additional heating function, that is to say can be used not only during stationary operation when the engine is switched off but also when the engine is running. Since heat is already supplied by an internal combustion engine when the engine is running, that is to say during additional heating operation, adjusted heating operating parameters are required in this case as compared with pure stationary heating operation. For example, a substantially lower heating power than during stationary heating operation can be provided. A stationary heating operating mode and an additional heating operating mode therefore constitute two different operating modes for a stationary heating system, it being possible to characterize said operating modes by virtue of different EOL data.

Said stationary heating systems or similar or identical heating devices are particularly often used in electric vehicles which generally only have a heating device of this kind to heat the interior since they do not have an internal combustion engine which could provide waste heat for heating the interior. Therefore, a stationary heating system or a similar heating device assumes the role of the sole driving-mode heating system in this case.

It is disadvantageous for the heating device, for example a stationary heating system, to be used in a mode which is unsuitable for the existing operating conditions, for example when the stationary heating system is frequently switched to and fro between load phases and control intervals in an operating mode on account of the predefined operating parameters, since the service life of the stationary heating system can be considerably reduced as a result.

The object of the present invention is to propose a control device for a heating device, a heating device and also a method for controlling a heating device for motor vehicles, which control device, heating device and method do not unnecessarily reduce the service life of the heating device and which allow optimum and efficient utilization of various operating modes of the heating device.

This object is achieved by the features of the independent claims.

Further advantageous refinements and developments of the invention can be gathered from the dependent claims.

A control device for a heating device for a motor vehicle is provided according to the invention, wherein the control device can actuate the heating device for operation in a first operating mode or a second operating mode based on an ambient temperature of the motor vehicle. Therefore, the ambient temperature or external temperature of the vehicle is taken into consideration when actuating the heating device. It is expedient to match one of the operating modes to operation at high ambient or external temperatures using suitable operating parameters, for example by a low heating power being provided. A further operating mode should be matched to operation at low ambient temperatures. The result of this can be that, for example, at a high ambient temperature, the heating device is actuated for operation in an operating mode in which the heating device can be operated in a particularly energy-saving manner on account of a low heating power. It is particularly advantageous for both operating modes to provide changeover operation. In this case, in which the operating mode provides load phases for heating, which load phases alternate with control intervals, relatively long heating phases can therefore be realized, so that frequent switching of the heating device between load phases and control intervals during changeover operation can be avoided. However, an operating mode with a relatively high heating power can be actuated at low ambient temperatures, so that a sufficient heating power is provided. In this case, the control device can be in the form of an electronic control device. In particular, the control device can be integrated in a control unit of a motor vehicle, such as an on-board computer, for example as a software component. The control device can also be in the form of part of the heating device. As an alternative, the control device can be provided as a separate component. Irrespective of this, it is feasible for the control device to be formed in such a way that it comprises a circuit which can have, for example, a thermal switch. A relay switch can be connected to the thermal switch. The control device can actuate the heating device by means of control inputs of the heating device. The control device according to the invention is particularly suitable for electric vehicles but can, of course, be used in other vehicles too. Provision may be made for the control device itself to generate an actuation signal for actuating the heating device, or to forward a signal, which is provided externally, for actuating the desired operating mode. A signal of this kind can be provided, for example, by an on-board electronics system of the vehicle or a remote control system. It is expedient for a threshold temperature to be defined. The control device can then be designed in such a way that it can actuate the heating device for operation in the first operating mode when the ambient temperature is below the threshold temperature. However, if the ambient temperature exceeds the threshold value in this case, the control device can actuate the heating device for operation in the second operating mode. The heating device can expediently be operated independently of an internal combustion engine. In particular, the heating device can be a stationary heating system or a driving-mode heating system of an electric vehicle. The heating device is particularly preferably a fuel-operated heating device, for example a burner which burns the vehicle fuel, or a fuel cell. The heating device can also be electrically operated. Provision may be made for the control device to be able to actuate the heating device in a specific operating mode, for example in the first operating mode or the second operating mode, based on an ambient temperature of the motor vehicle for and/or during long-term operation. Therefore, a suitable operating mode can be selected or actuated during normal heating operation, in particular outside a start phase of the heating device, as a function of the ambient temperature. Therefore, in the case of relatively long journeys, the control device can, for example, react to changes in the external temperature and optionally set a suitable and efficient operating mode. In particular, the control device can be designed to actuate the heating device as a function of the ambient temperature for long-term operation in the more suitable of the defined operating modes, in particular for operation in the first operating mode or in the second operating mode. It is feasible for the control device to be designed to actuate the heating device for long-term operation in a specific operating mode after a start operation.

The control device advantageously has a device for detecting the ambient temperature. Said device can be, for example, a thermal switch, as already mentioned, which detects, for example, whether a temperature threshold has been exceeded, or a temperature sensor. In this way, the control device is of simple construction and can be used independently of existing sensors in the vehicle. This makes it possible, for example, to retrofit the control device to a motor vehicle which does not have any suitable ambient temperature sensors.

In a development, provision is made for the control device to be able to receive a signal which is based on the ambient temperature of the motor vehicle. In particular, the control device can be designed to receive a signal of this kind from an existing ambient temperature sensor or from the on-board electronics system of the motor vehicle. Therefore, existing components can also be used for the control device for the heating device. In this case, it is particularly advantageous for the control device to be connected to a bus system of the on-board electronics system, for example a CAN bus.

In one embodiment, the heating device is operated with a different heating power in the first operating mode than in the second operating mode. The heating power is one of the most important parameters during operation of the heating device. A sufficient heating power can be provided, without placing an unnecessary load on the heating device, by using operating modes with different heating powers.

Particularly preferably, the heating device is a stationary heating system and the first operating mode is a stationary heating operating mode. A mode of this kind is generally already defined for operation of the stationary heating system, and therefore this can expediently be actuated for operation of the stationary heating system.

Provision can also be made for the heating device to be a stationary heating system and for the second operating mode to be an additional heating operating mode. An additional heating operating mode of this kind generally provides a lower heating power than a stationary heating operating mode. This is particularly expedient in the case of vehicles with an internal combustion engine which gives off little waste heat, an additional heating operating mode of this kind generally being defined for said vehicles. If the vehicle is an electric vehicle, it may be expedient for the heating device to be a driving-mode heating system. Since, in the case of an electric vehicle, a motor generally does not provide any appreciable waste heat, which can be used for heating the vehicle interior, as compared with an internal combustion engine, an operating mode for high ambient temperatures can be defined instead of an additional heating operating mode and/or an operating mode for low ambient temperatures can be defined instead of a stationary heating operating mode. However, it may also be expedient to use an additional heating operating mode which has already been defined, or a similar operating mode, in the case of a vehicle without an internal combustion engine, such as an electric vehicle, for example if the ambient temperature is high enough for operation at a low heating power even without waste heat from an engine. In this case, the additional heating operating mode can be considered to be the operating mode for high ambient temperatures.

In a preferred embodiment, provision is made for the control device to be able to actuate the heating device based on an ambient temperature for operation in a third operating mode or further operating modes. Therefore, actuation of the heating device can be carried out in a more flexible manner and primarily be further optimized. The operating modes for associated ambient temperature ranges are advantageously optimized. In this case, it is expedient to define a suitable number of temperature threshold values (two for three operating modes or correspondingly more for more than three operating modes) in order to establish temperature ranges in which an operating mode can be actuated in each case. In particular, a first and a second temperature threshold value can be defined in the case of three operating modes, with the first threshold value being below the second. In this embodiment, the control device is designed to actuate the heating device for operation in the first operating mode when the ambient temperature is below the first threshold value, and for operation in the second operating mode when the ambient temperature is between the first and the second threshold value. Furthermore, the control device can, in this example, actuate the heating device for operation in the third operating mode when the ambient temperature is above the second threshold value.

A heating device for a motor vehicle having a control device as described above is also proposed according to the invention. The heating device can be operated independently of an internal combustion engine. In particular, provision can be made for the heating device to be a stationary heating system or a driving-mode heating system for an electric vehicle. The heating device is particularly preferably a fuel-operated heating device, for example a burner which burns vehicle fuel, or a fuel cell. The heating device can also be electrically operated.

The invention also relates to a motor vehicle having a heating device of this kind and/or a control device of this kind. In particular, provision may be made for a vehicle to be produced without a heating device of this kind, but to be prepared for actuation of a heating device or a stationary heating system or driving-mode heating system, for example by providing corresponding functions in a central control unit or the on-board electronics system.

A method for controlling a heating device for a motor vehicle is also provided according to the invention, in which method the heating device is actuated for operation in a first operating mode or a second operating mode based on an ambient temperature of the motor vehicle. In the case of the method described here, an above-described control device or an above-described heating device can be used in particular. The method can be carried out during and/or for long-term operation of the heating device.

In particular, a control device can detect the ambient temperature.

Provision may be made for a signal which is based on the ambient temperature of the motor vehicle to be received.

In one embodiment, the heating device can be operated with a different heating power in the first operating mode than in the second operating mode.

The first operating mode is particularly preferably a stationary heating operating mode.

The second operating mode can also be an additional heating operating mode.

In one embodiment, provision is made for the heating device to be actuated for operation in a first, second or third operating mode. As mentioned above, more than three operating modes can be provided for actuation based on the ambient temperature.

The advantages cited above as part of the description of the control device apply to said heating devices, motor vehicles and method in a corresponding manner.

As part of this description, provision is made for an operating mode of a heating device to define parameters or parameter ranges for operation of the heating device. In this case, a distinction is drawn between different operating modes in respect of at least one operating parameter. An important parameter for an operating mode is the heating power with which the heating device is operated. Further parameters can be, in particular, switching temperatures at which a load phase or a control interval is initiated within an operating mode. An operating mode can be defined by one or more heating operating parameters. Parameters of this kind can be, for example, one or more heating power values and also switching thresholds. A switching threshold can define, for example, a temperature of the medium which is to be heated, at which a specific actuation of the heating device is to be performed. For example, a switching threshold can define the medium temperature at which a specific heating power of the heating device is to be actuated and/or the temperatures at which the heating device is to be switched on or switched off. The operating parameters can also comprise one or more target temperatures. A situation of the actuation of the heating device being dependent on the ambient temperature can therefore be achieved in a simple manner by virtue of the described actuation for operation in a suitable operating mode such as the first operating mode or the second operating mode as a function of the ambient temperature. In this case, it is not necessary, for example, to define complex temperature relationships in the control data sets of the heating device. In particular, operating modes which have already been defined can continue to be used without modification. It is feasible for the operating parameters to specify functional relationships between a target temperature and/or an actual medium temperature and/or a heating power which is to be introduced. It is particularly expedient for the control device to be able to actuate the heating device for operation in a first operating mode or a second operating mode based on an ambient temperature of the motor vehicle for and/or during long-term operation. During long-term operation, the heating device can provide an actuated heating power for heating the medium in accordance with the control device. Long-term operation is to be distinguished from starting operation in which, for example, a heating flame is generated and/or the heating device has to be adjusted to a suitable operating temperature before it can provide its desired heating power for long-term operation. Long-term operation can be carried out after starting operation in which the heating power is adjusted to the operating temperature. The parameters can be contained, in particular, in a so-called EOL data set. In this case, an EOL data set can contain the parameters for one or more operating modes. A plurality of data sets for describing the operating modes can also be provided. In general, operating parameters, in particular the heating power, can be varied over time in an operating mode, for example within predefined parameter ranges. In this case, one or more operating parameters are preferably varied based on the ambient temperature. An operating mode can involve continuous heating operation. Changeover operation can also be provided, in which load or heating phases under partial load or full load are interrupted by heating intervals or control intervals in which the heating device is not subjected to the action of a load. Therefore, a state in which the heating device is completely switched off for a long period of time is not an operating mode within the meaning of this description. It is advantageous for the operating modes to be designed for operation in a specific ambient temperature range in each case. Actuation of the heating device for operation in a specific operating mode is intended to implement selection of the specific operating mode in order to ensure the most optimum operation possible for a specific ambient temperature. In this case, it is not necessary for this actuation to be accompanied by the heating device being switched on. Rather, the heating device can be switched on on the basis of a signal which is independent of the selection of the operation mode. However, it is also possible for actuation for operation in an operating mode to be associated with the heating device being switched on, for example by the control device responding to a specific control input or conducting a switch-on signal to a specific control input in order to thus implement selection of the operating mode. Furthermore, the heating device can be controlled independently of further signals or actuation operations by the proposed control device according to the specified operating parameters of the selected operating mode, for example by a control unit which is separate from the control device and is associated with the heating device, after actuation or selection of the operating mode has been performed. However, provision can also be made for the control device to also be designed to control the heating device in accordance with the operating parameters of the actuated operating mode. The heating device serves preferably to heat a medium, the heat from said medium being provided, for example, for a downstream interior heating system as was described above with reference to a stationary heating system.

The invention will now be explained by way of example using preferred exemplary embodiments with reference to the accompanying drawings, in which.

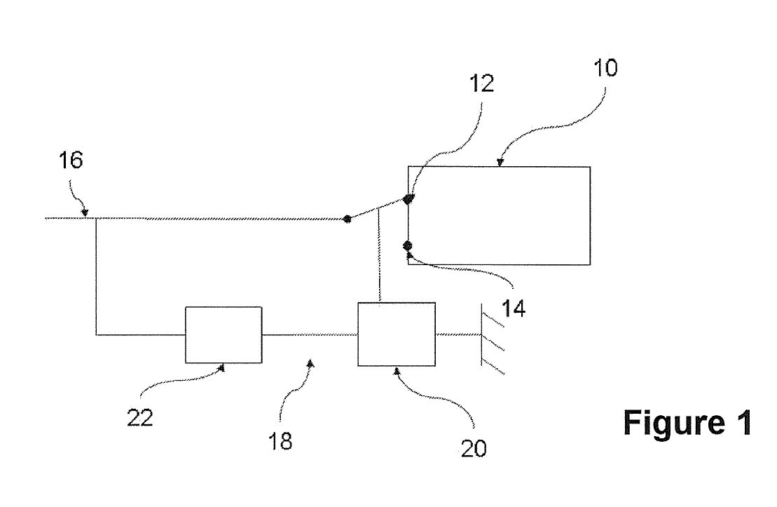

FIG. 1 shows a schematic view of a stationary heating system and

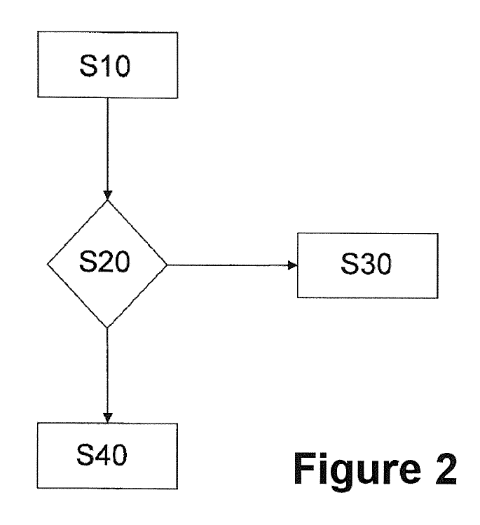

FIG. 2 shows a schematic flowchart of a method for controlling a stationary heating device.

FIG. 1 schematically shows a partial view of a heating device, in this example a stationary heating system 10. The stationary heating system 10 is designed to be operated in at least two operating modes. In this case, the first operating mode constitutes a stationary heating operation with an associated EOL data set which establishes, for example, the heating power, heating duration, switch-on and switch-off conditions. The second operating mode constitutes an additional heating operating mode which is likewise defined by associated EOL data. The additional heating operation makes provision, for example, for the stationary heating system 10 to be operated with different operating parameters than during stationary heating operation. The mentioned operation of the heating device can be long-term operation which is carried out after a starting operation in which the heating system is adjusted to the operating temperature.

The stationary heating system 10 also has two control inputs 12 and 14. If the stationary heating system 10 is addressed by the control input 12, this leads to the stationary heating system 10 being operated in the stationary heating operating mode. The input 12 is accordingly referred to as the stationary heating input. In contrast, actuation of the stationary heating system 10 by means of the control input 14 leads to the stationary heating system 10 being operated in the additional heating operating mode. The input 14 is accordingly also referred to as the additional heating input. The stationary heating system 10 is connected to an actuation line 16. A signal can be forwarded to the stationary heating system 10 by means of one of the control inputs 12, 14 via the actuation line 16, said signal switching said stationary heating system to a corresponding operating mode. The actuation signal or start signal which is applied via the control line 16 can be triggered, for example, by a remote control means, a timer or similar known measures. A control device 18 is connected upstream of the control inputs 12 and 14 of the stationary heating system 10. In the example shown here, the control device 18 comprises a relay circuit 20 and a thermal switch 22. The relay circuit 20 is formed in such a way that it can connect the actuation line 16 either to the stationary heating input 12 or to the additional heating input 14. The switching position of the relay circuit 20 is determined by a thermal switch 22 which is connected upstream of said relay circuit. The relay 20 is expediently set in such a way that the stationary heating input 12 is actuated in the standard position of said relay. Furthermore, the relay circuit 20 is also coupled to ground in order to be at a defined potential. The thermal switch 22 is intended to either itself react directly to an ambient temperature or to have an ambient temperature sensor, that is to say to detect the ambient temperature or to receive a signal which indicates the ambient temperature of the motor vehicle. A signal of this kind can be provided, for example, by an on-board electronics system via a CAN bus (not shown). A signal which is based on the ambient temperature is supplied to the relay 20 by means of the thermal switch 22. Provision is made, in particular, for the thermal switch 22 to generate a different signal if the ambient temperature is below a specific threshold value T_{G} than if the ambient temperature is equal to or above the threshold value T_{G}. On the basis of this signal, the relay circuit 20 switches the actuation line 16 either to the stationary heating input 12 to the additional heating input 14. If the ambient temperatures are above or equal to the threshold value T_{G}, moderate temperatures are present, it being possible for these temperatures to make intense and frequent heating by the stationary heating system unnecessary. In this case, the relay 20 receives a signal from the thermal switch 22 and switches in such a way that the additional heating input 14 is actuated. Secondly, the control device 18 is formed in such a way that the stationary heating system 12 is actuated at temperatures which are below the threshold temperature T_{G}. In this case, low ambient temperatures make it expedient to operate the stationary heating system in the stationary heating operating mode. The threshold temperature T_{G} is expediently established at approximately 10° C. Provision may also be made for a signal to be forwarded to the relay 20 only for one of the temperature ranges above or below the threshold temperature T_{G}. For example, provision may be made for a signal for switching over the relay 20 to be generated only when the ambient temperature is above the threshold temperature T_{G}. If the ambient temperature is below the threshold temperature T_{G}, the relay 20 then remains in its standard position in which the stationary heating system 12 can be actuated. It goes without saying that the standard mode provided can also be the additional heating operating mode. In this case, the thermal switch 22 expediently generates a signal for switching over the relay 20 when the ambient temperature is below the threshold value T_{G}.

Therefore, the operating mode of the stationary heating device is set based on the ambient temperature when an actuation signal is input via the actuation line 16. It goes without saying that the control device 18 can also be formed in a different way. In particular, it is not necessary to use a thermal switch and a relay as shown. Instead, the control device 18 can also be formed by software or hardware and be associated with a controller which receives an ambient temperature signal. The operating mode of the stationary heating system can then be actuated, for example, by software on the basis of the ambient temperature signal. It is also unnecessary to use the stationary heating operating mode and the additional heating operating mode as operating modes, even if these modes can be used in a particularly expedient manner. Instead, any suitable operating modes can be actuated. Provision may also be made for more than one operating mode to be actuated on the basis of the ambient temperature. In this case, a plurality of threshold temperatures can be defined.

FIG. 2 schematically shows a method for controlling a stationary heating system, said stationary heating system being, for example, a stationary heating system 10 as described in FIG. 1. An ambient temperature T of the motor vehicle is determined in a step S10. A check is made in step S20 to determine whether this measured ambient temperature T is above a temperature threshold value T_{G}. If this is not the case, step S30 is executed. Otherwise, the method branches to step S40. In step S30, the stationary heating system is actuated for operation in a first operating mode which is preferably matched to relatively low ambient temperatures. Said first operating mode may be, for example, a stationary heating operating mode as already mentioned. In step S40, the stationary heating system is actuated for operation in a second operating mode. This operating mode is preferably matched to higher ambient temperatures and can be, for example, an additional heating operating mode. This method can preferably be carried out during and/or for long-term operation, in particular independently of a starting operation of the heating system.

The features of the invention disclosed in the above description, in the drawings and in the claims may be essential for realizing the invention both individually and in any possible combination.

### LIST OF REFERENCE SYMBOLS

10 Stationary heating system
12 Control input
14 Control input
16 Actuation line
18 Control device
20 Relay circuit
22 Thermal switch
T_{G} Threshold temperature

1. A control device for a heating device for a motor vehicle, wherein the control device is configured to actuate the heating device for operation in a first operating mode or a second operating mode based on an ambient temperature of the motor vehicle.

2. The control device as claimed in claim 1, wherein the control device has a device for detecting the ambient temperature.

3. The control device as claimed in claim 1, wherein the control device is configured to receive a signal which is based on the ambient temperature of the motor vehicle.

4. The control device as claimed in claim 1, wherein the heating device is operated with a different heating power in the first operating mode than in the second operating mode.

5. The control device as claimed in claim 1, wherein the heating device is a stationary heating system and the first operating mode is a stationary heating operating mode.

6. The control device as claimed in claim 1, wherein the heating device is a stationary heating system and the second operating mode is an additional heating operating mode.

7. The control device as claimed in claim 1, wherein the control device is configured to actuate the heating device for operation in a third operating mode or further operating modes.

8. A heating device for a motor vehicle comprising the control device as claimed in claim 1.

9. A motor vehicle having the heating device as claimed in claim 8.

10. A method for controlling a heating device for a motor vehicle the method comprising actuating the heating device for operation in a first operating mode or a second operating mode based on an ambient temperature of the motor vehicle.

11. A heating device controller for a motor vehicle, wherein the controller is configured to actuate a heating device for operation in one of a plurality of operating modes based on an ambient temperature of the motor vehicle.

12. A motor vehicle comprising the heating device with the controller as claimed in claim 11.

13. A method for controlling the heating device for a motor vehicle as claimed in claim 11, the method comprising actuating the heating device for operation in one of the plurality of operating modes based on the ambient temperature of the motor vehicle.
